(19) United States
(12) Patent Application Publication
(10) Pub. No.: US 2022/0065998 A1
(43) Pub. Date: Mar. 3, 2022

(54) DISTANCE MEASUREMENT DEVICE

(71) Applicant: KABUSHIKI KAISHA TOSHIBA, Tokyo (JP)

(72) Inventors: Masatoshi HIRONO, Yokohama (JP); Hiroshi KUBOTA, Yokohama (JP); Nobu MATSUMOTO, Ebina (JP)

(73) Assignee: KABUSHIKI KAISHA TOSHIBA, Tokyo (JP)

(21) Appl. No.: 17/466,367

(22) Filed: Sep. 3, 2021

(30) Foreign Application Priority Data
Sep. 3, 2020 (JP) 2020-148385
Sep. 2, 2021 (JP) 2021-143369

(51) Int. Cl. G01S 7/481; G02B 26/08; G02B 26/10

(52) U.S. Cl. CPC G01S 7/4817; G02B 26/10; G02B 26/0816

(57) ABSTRACT

According to one embodiment, a distance measurement device includes a light projecting unit and a light receiving unit. The light projecting unit projects light to a target. The light receiving unit detects the light reflected by the target. The light projecting unit includes a light source emitting light, a first reflecting surface allowing the light to partially pass through the first reflecting surface, and a second reflecting surface facing the first reflecting surface and reflecting the light. The light is reflected a plurality of times by each of the first reflecting surface and the second reflecting surface.

### CROSS-REFERENCE TO RELATED APPLICATIONS

This application is based upon and claims the benefit of priority from Japanese Patent Application No. 2020-148385, filed on Sep. 3, 2020, and Japanese Patent Application No. 2021-143369, filed on Sep. 2, 2021; the entire contents of which are incorporated herein by reference.

### FIELD

Embodiments described herein relate generally to a distance measurement device.

### BACKGROUND

There is a device for measuring a distance by using light. Output of the light emitted from a light source is desirable to be large for the distance measurement device.

### BRIEF DESCRIPTION OF THE DRAWINGS

FIG. 1 is a schematic view showing a configuration of the distance measurement device according to the first embodiment;

FIG. 2 is a perspective view showing a portion of the distance measurement device according to the first embodiment;

FIG. 3 is a schematic view showing a portion of the distance measurement device according to the first embodiment;

FIG. 4 is a perspective view showing a portion of a distance measurement device according to a first variation of the first embodiment;

FIG. 5 is a schematic view showing a portion of a distance measurement device according to a second variation of the first embodiment;

FIG. 6A and FIG. 6B are side views showing a portion of a distance measurement device according to a second embodiment;

FIG. 7A and FIG. 7B are schematic views showing a portion of the distance measurement device according to the second embodiment; and

FIG. 8A and FIG. 8B are schematic views showing a portion of a distance measurement device according to a first variation of the second embodiment.

### DETAILED DESCRIPTION

According to one embodiment, a distance measurement device includes a light projecting unit and a light receiving unit. The light projecting unit projects light to a target. The light receiving unit detects the light reflected by the target. The light projecting unit includes a light source emitting light, a first reflecting surface allowing the light to partially pass through the first reflecting surface, and a second reflecting surface facing the first reflecting surface and reflecting the light. The light is reflected a plurality of times by each of the first reflecting surface and the second reflecting surface.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

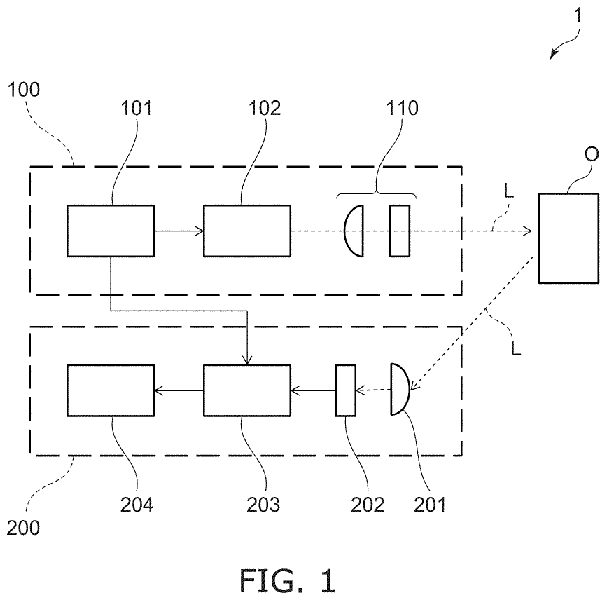

FIG. 1 is a schematic view showing a configuration of the distance measurement device according to the first embodiment.

As shown in FIG. 1, a distance measurement device 1 according to the first embodiment includes a light projecting unit 100 and a light receiving unit 200. The light projecting unit 100 projects light L to a target O. The light receiving unit 200 detects the light L reflected by the target O. The light receiving unit 200 measures the distance to the target O based on the detected light L.

The light projecting unit 100 includes a circuit part 101, a light source 102, and an optical system 110. The light source 102 emits the light L. For example, the light source 102 includes a laser beam oscillator. The light L is a near-infrared laser beam. The circuit part 101 supplies a current to the light source 102 to drive the light source 102. The light L emitted from the light source 102 passes through the optical system 110 and hits the target O.

The light receiving unit 200 includes an optical system 201, a light receiving element 202, a measurement circuit 203, and a recognition system 204. The optical system 201 converges the light L reflected by the target O on the light receiving element 202. The light receiving element 202 detects the light L. The light receiving element 202 includes, for example, a photodiode.

The measurement circuit 203 receives a detection signal from the light receiving element 202. The measurement circuit 203 receives a modulation signal transmitted to the light source 102 from the circuit part 101. A time difference from the time of receiving the modulation signal to the time of receiving the detection signal is proportional to the distance between the distance measurement device 1 and the target O. The measurement circuit 203 measures the distance of the target O by an optical flight time distance measurement method based on the time difference. The recognition system 204 recognizes the target O based on the result measured by the measurement circuit 203. The measurement circuit 203 and the recognition system 204 may be incorporated in the light receiving unit 200 as shown in FIG. 1 or may be provided separately from the light receiving unit 200.

For example, the distance measurement device 1 can be applied to a light detection and ranging (LIDAR) device.

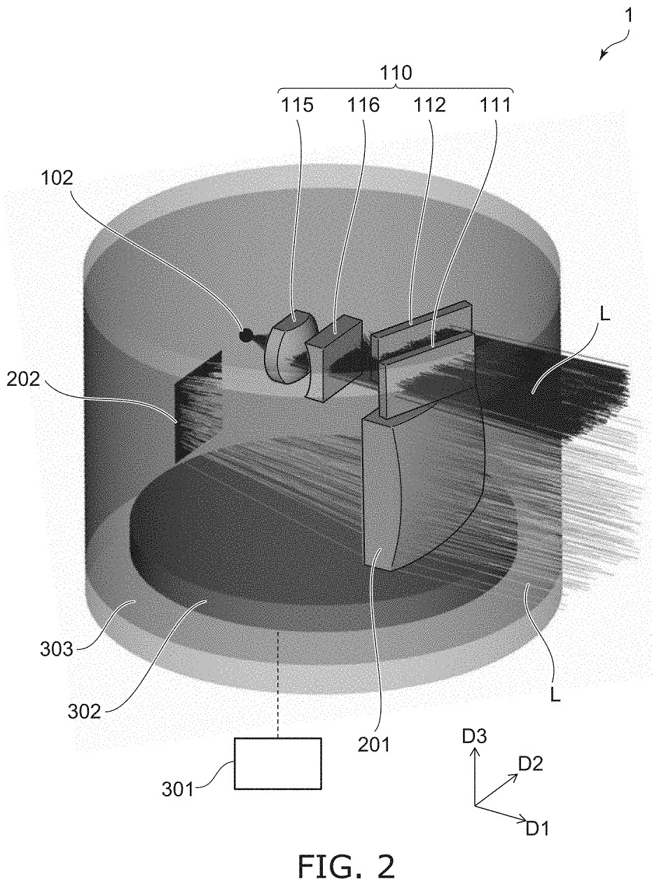

FIG. 2 is a perspective view showing a portion of the distance measurement device according to the first embodiment.

For example, as shown in FIG. 2, the optical system 110 includes a first reflecting surface 111, a second reflecting surface 112, a collimator lens 115, and a plano-concave cylindrical lens 116.

The light source 102 emits the light L toward a first direction D1. The light L is incident on the collimator lens 115 and is aligned in parallel to the first direction D1. The parallel light L is incident on a concave surface of the cylindrical lens 116. The concave surface is parallel to a second direction D2 perpendicular to the first direction D1 and is curved in a third direction D3 perpendicular to the first direction D1 and the second direction D2. The light L is diffused in the third direction D3 by the cylindrical lens 116.

The light L passing through the cylindrical lens 116 is incident on the first reflecting surface 111. The first reflecting surface 111 allows the light L to partially pass through the first reflecting surface 111. That is, a portion of the light L passes through the first reflecting surface 111. Another portion of the light L is reflected by the first reflecting surface 111.

The second reflecting surface 112 faces the first reflecting surface 111. The light L reflected by the first reflecting surface 111 is incident on the second reflecting surface 112. The second reflecting surface 112 reflects the light L. The light L reflected by the second reflecting surface 112 is incident again on the first reflecting surface 111. The light L is reflected multiple times by each of the first reflecting surface 111 and the second reflecting surface 112. Each time the light L is incident on the first reflecting surface 111, the light L partially passes through the first reflecting surface 111.

The light L reflected between the first reflecting surface 111 and the second reflecting surface 112 finally travels toward the first direction D1 without being incident on the first reflecting surface 111. The first reflecting surface 111 and the second reflecting surface 112 are parallel to the third direction D3 and are inclined with respect to the first direction D1 and the second direction D2. Due to the transmission of the first reflecting surface 111 and the reflection between the first reflecting surface 111 and the second reflecting surface 112, the light L is divided and widened in the second direction D2 as shown in FIG. 2. The divided light L is projected toward the target O.

The light L reflected by the target O passes through the optical system 201, which is a condensing lens, and is converged toward the light receiving element 202. The light receiving element 202 spreads along the second direction D2 and the third direction D3 and detects the light L at multiple points.

In the example shown in FIG. 2, the distance measurement device 1 further includes a driving part 301, a rotating part 302, and a casing 303. The light source 102, the optical system 110, the optical system 201, and the light receiving element 202 are rotated around the third direction D3 by the rotating part 302. The driving part 301 includes a motor, an actuator, or the like and drives the rotating part 302. The path of the light L emitted from the light projecting unit 100 and the detecting direction of the light L by the light receiving unit 200 change according to the rotation of the rotating part 302.

For example, the rotating part 302 is a stage. The light source 102, the optical system 110, the optical system 201, and the light receiving element 202 are mounted on the stage and accommodated in the casing 303. The stage rotates around the third direction D3 in the casing 303.

In the light projecting unit 100, the specific configuration of the optical system between the light source 102 and the first reflecting surface 111 is not limited to the example shown in FIG. 2 and can be appropriately changed. Another optical system may be provided subsequent to the second reflecting surface 112. Similarly, in the light receiving unit 200, the specific configuration of the optical system 201 can be appropriately changed.

The effect of the first embodiment will be described.

The distance measurement device 1 is required to have a high output of light L emitted from the light source 102. By increasing the output of the light L, the amount of light that hits the target O increases. As a result, the amount of light reflected by the target O is increased, and thus, a larger signal can be obtained in the light receiving unit 200. For example, by improving the SN ratio, the distance to a distant target O can be measured more accurately. On the other hand, the distance measurement device 1 is also required to be safe. When the light L is incident on the human eye, as the amount of light is large, there is a possibility that the large amount of light may harm the eyes. The amount of light incident on the eye depends on illuminance, which is an intensity of the light L per unit area. That is, the distance measurement device 1 is required to improve the total amount of light while suppressing the increase in illuminance.

In the distance measurement device 1, the light projecting unit 100 includes the first reflecting surface 111 and the second reflecting surface 112. As shown in FIG. 2, the light L is divided into multiple light beams L in the second direction D2 by the first reflecting surface 111 and the second reflecting surface 112. Accordingly, the illuminance of the light L can be reduced even when the output of the light L emitted from the light source 102 is increased and the amount of light is increased. For example, the output of the light L can be increased, and an SN ratio of the distance measurement device 1 can be improved while maintaining the illuminance and the safety.

According to the first embodiment, the illuminance of the light L can be effectively reduced, and the light projecting unit 100 can be miniaturized in comparison with a case where a beam expander or the like is used.

The second reflecting surface 112 may be parallel to the first reflecting surface 111 or may be inclined with respect to the first reflecting surface 111. It is favorable that the angle between the first reflecting surface 111 and the second reflecting surface 112 is less than 20 degrees.

When light transmittance of the first reflecting surface 111 is too small or too large, the variation in illuminance of the divided light L becomes large. In order to reduce the variation in illuminance of the divided light L, it is favorable that the light transmittance of the first reflecting surface 111 is not less than 10% and not more than 40%. The light transmittance of the second reflecting surface 112 is lower than the light transmittance of the first reflecting surface 111. In order to increase the amount of light that hits the target O, it is favorable that the light reflectance of the second reflecting surface 112 is 90% or more.

Inclination angles of the first reflecting surface 111 and the second reflecting surface 112 with respect to the second direction D2 are appropriately set according to the width of the light L emitted from the light source 102, the number of times of reflection by the first reflecting surface 111 and the second reflecting surface 112, and the like. However, when the angle is too small, the distance between the divided light beams L in the second direction D2 becomes small, and thus, the illuminance cannot be sufficiently reduced. When the angle is too large, it is necessary to increase the sizes of the first reflecting surface 111 and the second reflecting surface 112 accordingly. From the viewpoint of reducing the illuminance and miniaturizing the optical system 110, it is favorable that the inclination angles of the first reflecting surface 111 and the second reflecting surface 112 with respect to the second direction D2 are not less than 10 degrees and not more than 45 degrees.

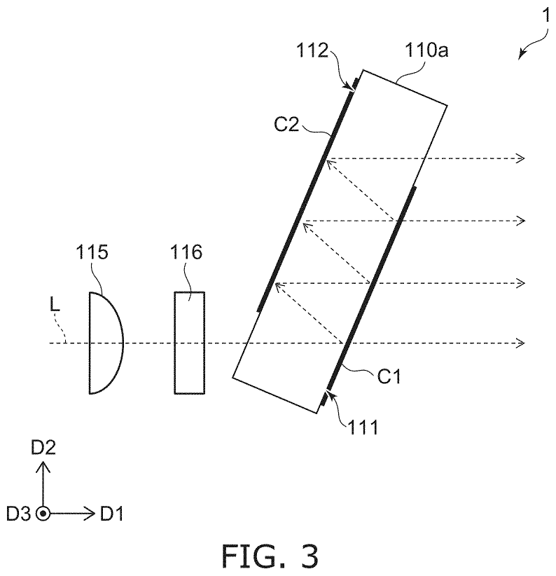

FIG. 3 is a schematic view showing a portion of the distance measurement device according to the first embodiment.

In FIG. 3, the path of the light L in the distance measuring device 1 is schematically shown. In addition, the refractions of the light L when the light L is incident on the first member 110a and when the light L is emitted from first member 110a are omitted in FIG. 3. The first reflecting surface 111 and the second reflecting surface 112 may be provided on different optical members as shown in FIG. 2. Alternatively, the first reflecting surface 111 and the second reflecting surface 112 may be provided on one first member 110a as shown in FIG. 3. For example, a coating (reflective film) C1 is formed on a portion of one surface of the first member 110a. A coating C2 is formed on a portion of the opposite surface of the first member 110a. The coating C1 allows the light L to partially pass through the coating C1. The coating C2 reflects light L. The coatings C1 and C2 respectively function as the first reflecting surface 111 and the second reflecting surface 112. The first member 110a allows the light L to pass through the first member 110a between the first reflecting surface 111 and the second reflecting surface 112. For example, the first member 110a is a prism having the first reflecting surface 111 and the second reflecting surface 112. The first member 110a is used, so that it is not necessary to adjust the positional relationship between the first reflecting surface 111 and the second reflecting surface 112. For example, the distance measurement device 1 can be easily manufactured. The variation in positional relationship between the first reflecting surface 111 and the second reflecting surface 112 can be reduced, and the variation in performance of the distance measurement device 1 can be reduced.

(First Variation)

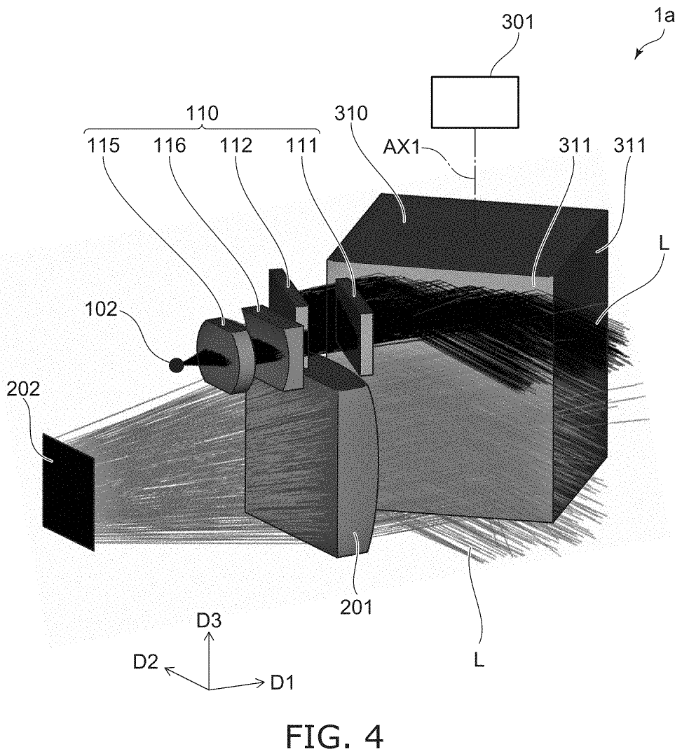

FIG. 4 is a perspective view showing a portion of a distance measurement device according to a first variation of the first embodiment.

In a distance measurement device 1a according to the first variation, as shown in FIG. 4, a first mirror 310 is provided instead of the rotating part 302. The first mirror 310 is a polygon mirror having multiple reflecting surfaces 311.

The light L reflected by the first reflecting surface 111 and the second reflecting surface 112 is incident on a portion of one reflecting surface 311 and reflected. The light L reflected by the target O is incident on the lower portion of the one reflecting surface 311 and is reflected toward the light receiving element 202. Accordingly, the reflected light L can be separated from the light L irradiated on the target O without using a perforated mirror, a half mirror, or the like. The optical loss can be reduced, and the SN ratio of the distance measurement device 1a can be improved.

For example, the first mirror 310 rotates or swings around a first axis AX1 parallel to the third direction D3. The direction connecting the portion of the one reflecting surface 311 and the other portion of the one reflecting surface 311 is parallel to the first axis AX1. The driving part 301 rotates the first mirror 310 around the first axis AX1. The path of the light L emitted from the light projecting unit 100 is changed according to the rotation of the first mirror 310.

The first mirror 310 is used, so that even when the incident angle of the light L on the reflecting surface 311 is large, the light L can be projected and received, and the viewing angle in the second direction D2 can be improved.

When the polygon mirror of the multiple reflecting surfaces 311 is used as the first mirror 310, the inclinations of the respective reflecting surfaces 311 with respect to the first axis AX1 may be different from each other. Accordingly, the reflection direction of the light L is allowed to be different for each reflecting surface 311, and thus, the viewing angle in the third direction D3 can be improved.

The first mirror 310 may be a rotating mirror having only one reflecting surface 311 and rotating around the first axis AX1. The rotating mirror is used, so that the size of the reflecting surface 311 can be increased while suppressing the increase in size of the first mirror 310 in comparison with a case where the polygon mirror is used. Accordingly, the SN ratio of the distance measurement device 1a can be improved.

The first mirror 310 may be a swinging mirror having only one reflecting surface 311 and swinging around the first axis AX1. The swinging mirror is used, so that the size of the first mirror 310 can be decreased in comparison with a case where the polygon mirror is used.

(Second Variation)

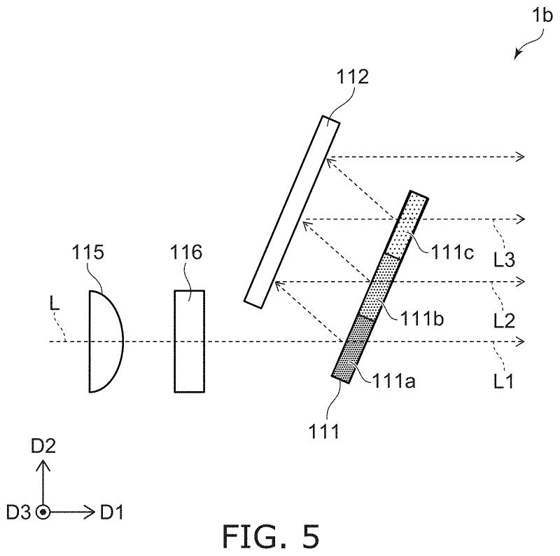

FIG. 5 is a schematic view showing a portion of a distance measurement device according to a second variation of the first embodiment.

In a distance measurement device 1b according to the second variation, the first reflecting surface 111 includes a first region 111a to a third region 111c. The light transmittances of the first region 111a to the third region 111c are different from each other.

In FIG. 5, the path of the light L in the distance measuring device 1b is schematically shown. In addition, the refractions of the light L when the light L is incident on each of the first reflecting surface 111 and the second reflecting surface 112 and when the light L is emitted from each of the first reflecting surface 111 and the second reflecting surface 112 are omitted in FIG. 5.

For example, the light L emitted from the light source 102 is first incident on the first region 111a. Next, the light L reflected by the second reflecting surface 112 is incident on the second region 111b. The light L further reflected by the second reflecting surface 112 is incident on the third region 111c.

When the light transmittance of the first reflecting surface 111 is uniform, the illuminance of light L2 passing through the second region 111b is smaller than the illuminance of light L1 passing through the first region 111a. The illuminance of light L3 passing through the third region 111c is smaller than the illuminance of the light L2 passing through the second region 111b. As the number of times of reflection by the first reflecting surface 111 and the second reflecting surface 112 is increased, the illuminance of the light passing through the first reflecting surface 111 is decreased. There is a variation in illuminance among the light L1 to the light L3.

In the distance measurement device 1b, as the number of times of reflection by the first reflecting surface 111 and the second reflecting surface 112 is increased, the transmittance of the region on which the light L is incident in the first reflecting surface 111 is increased. Accordingly, the variation in illuminance among the light L1 to the light L3 can be reduced.

The number of regions in the first reflecting surface 111 in which the light transmittances are different from each other can be appropriately changed according to the number of times of reflection of the light L between the first reflecting surface 111 and the second reflecting surface 112. When the light L is reflected multiple times by each of the first reflecting surface 111 and the second reflecting surface 112, it is favorable that the first reflecting surface 111 includes at least three regions.

### Second Embodiment

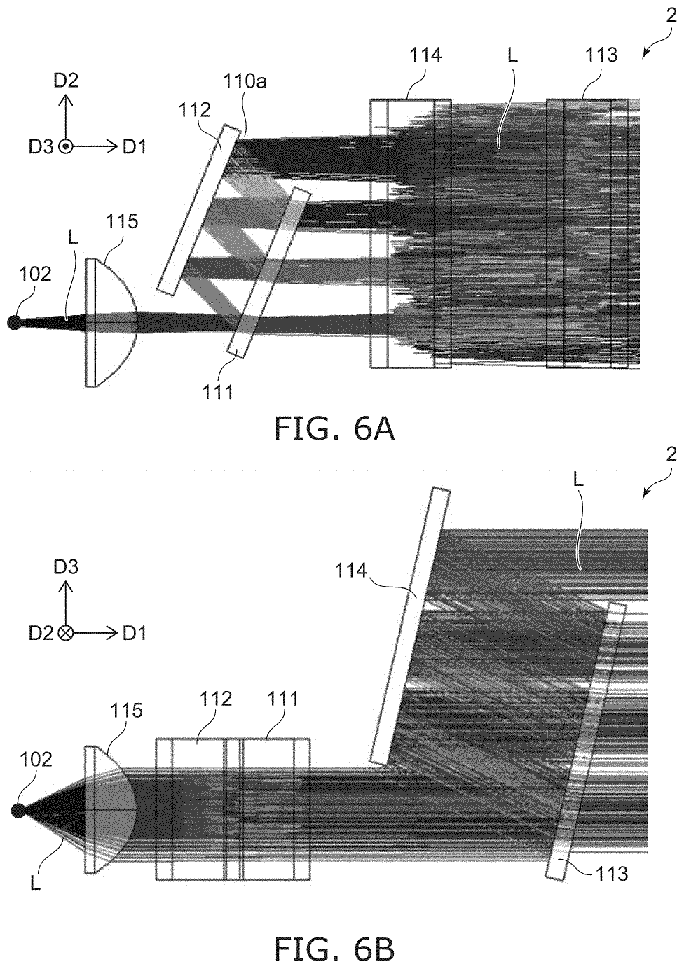

FIG. 6A and FIG. 6B are side views showing a portion of a distance measurement device according to a second embodiment.

FIG. 6A shows a state when a distance measurement device 2 is viewed from the third direction D3. FIG. 6B shows a state when the distance measurement device 2 is viewed from the second direction D2. In the distance measurement device 2 according to the second embodiment, the optical system 110 further includes a third reflecting surface 113 and a fourth reflecting surface 114. The optical system 110 does not include the cylindrical lens 116.

As shown in FIG. 6A, similarly to the distance measurement device 1, the first reflecting surface 111 and the second reflecting surface 112 divide the light L into multiple light beams L in the second direction D2.

As shown in FIG. 6B, the third reflecting surface 113 allows the light L to partially pass through the third reflecting surface 113. That is, a portion of the light L passes through the third reflecting surface 113. Another portion of the light L is reflected by the third reflecting surface 113.

The fourth reflecting surface 114 faces the third reflecting surface 113. The light L reflected by the third reflecting surface 113 is incident on the fourth reflecting surface 114. The fourth reflecting surface 114 reflects the light L. The light L reflected by the fourth reflecting surface 114 is incident again on the third reflecting surface 113. The light L is reflected multiple times by each of the third reflecting surface 113 and the fourth reflecting surface 114. Each time the light L is incident on the third reflecting surface 113, the light L partially passes through the third reflecting surface 113.

The light L reflected between the third reflecting surface 113 and the fourth reflecting surface 114 finally travels toward the first direction D1 without being incident on the third reflecting surface 113. The third reflecting surface 113 and the fourth reflecting surface 114 are parallel to the second direction D2 and are inclined with respect to the first direction D1 and the third direction D3. For this reason, as shown in FIG. 6B, the light L is divided into multiple light beams L in the third direction D3.

According to the distance measurement device 2 according to the second embodiment, the light L is divided into the multiple light beams L in each of the second direction D2 and the third direction D3. For this reason, the illuminance of the light L emitted from the light source 102 can be further reduced in comparison with the first embodiment. For example, in comparison with the first embodiment, the output of the light L can be further increased while maintaining the illuminance.

As shown in FIG. 6A and FIG. 6B, the light reflected by the first reflecting surface 111 and the second reflecting surface 112 may be incident on the third reflecting surface 113 and the fourth reflecting surface 114. Alternatively, the light reflected by the third reflecting surface 113 and the fourth reflecting surface 114 may be incident on the first reflecting surface 111 and the second reflecting surface 112.

For example, the diameter of the light emitting surface of the light source 102 in the second direction D2 is larger than the diameter of the light emitting surface in the third direction D3. Accordingly, as shown in FIG. 6A and FIG. 6B, immediately after transmitting the collimator lens 115, the diameter (full width at half maximum) of the light L emitted from the light source 102 in the second direction D2 is smaller than the diameter (full width at half maximum) of the light L in the third direction D3. In this case, it is favorable that the light L is first incident on the first reflecting surface 111 and the second reflecting surface 112.

In general, after transmitting the collimator lens 115, the light L is likely to spread in a direction having a larger diameter of the light emitting surface as the light L travels. As the light L spreads, the size of the reflecting surface also needs to be increased. In a case where the diameter of the light emitting surface in the second direction D2 is larger than the diameter in the third direction D3, the light L is more likely to spread in the second direction D2 than in the third direction D3 after transmitting the collimator lens 115. In a case where the light L is first incident on the third reflecting surface 113 and the fourth reflecting surface 114, the light L is divided in the third direction D3 and spreads in the second direction D2. Accordingly, it is necessary to increase the size of each of the first reflecting surface 111 and the second reflecting surface 112 in the second direction D2, i.e. in the D1-D2 plane. As a result, the optical system 110 is increased in size.

The light L is first incident on the first reflecting surface 111 and the second reflecting surface 112 in a state where the diameter in the second direction D2 is small, so that the size of each of the first reflecting surface 111 and the second reflecting surface 112 in the second direction D2, i.e. in the D1-D2 plane, can be decreased. As a result, the optical system 110 can be miniaturized.

The fourth reflecting surface 114 may be parallel to the third reflecting surface 113 or may be inclined with respect to the third reflecting surface 113. It is favorable that the angle between the third reflecting surface 113 and the fourth reflecting surface 114 is less than 20 degrees. For example, the first reflecting surface 111 and the second reflecting surface 112 are parallel to each other, and the third reflecting surface 113 and the fourth reflecting surface 114 are parallel to each other. The normal directions of the first reflecting surface 111 and the second reflecting surface 112 are orthogonal to the normal directions of the third reflecting surface 113 and the fourth reflecting surface 114.

When the light transmittance of the third reflecting surface 113 is too small or too large, the variation in illuminance of the divided light L is increased. In order to reduce the variation in illuminance of the divided light L, it is favorable that the light transmittance of the third reflecting surface 113 is not less than 10% and not more than 40%. The light transmittance of the fourth reflecting surface 114 is lower than the light transmittance of the third reflecting surface 113. In order to increase the amount of light that hits the target O, it is favorable that the light reflectance of the fourth reflecting surface 114 is 90% or more.

The inclination angles of the third reflecting surface 113 and the fourth reflecting surface 114 with respect to the second direction D2 are appropriately set according to the width of the light L emitted from the light source 102, the number of times of reflection by the third reflecting surface 113 and the fourth reflecting surface 114, and the like. However, when the angle is too small, the distance between the divided light beams L in the third direction D3 becomes short, so that the illuminance cannot be sufficiently reduced. When the angle is too large, it is necessary to increase the sizes of the third reflecting surface 113 and the fourth reflecting surface 114. From the viewpoint of reducing the illuminance and miniaturizing the optical system 110, it is favorable that the inclination angles of the third reflecting surface 113 and the fourth reflecting surface 114 with respect to the second direction D2 are not less than 10 degrees and not more than 45 degrees.

The light transmittance of the first reflecting surface 111 may be substantially the same as the light transmittance of the third reflecting surface 113 or may be different from the light transmittance of the third reflecting surface 113. “Substantially the same” includes a case where the light transmittances of the two reflecting surfaces are completely the same and a case where the difference in light transmittance is 20% or less.

The number of times of reflection of the light L by each of the first reflecting surface 111 and the second reflecting surface 112 may be the same as the number of times of reflection of the light L by each of the third reflecting surface 113 and the fourth reflecting surface 114. The number of times of reflection of the light L by each of the first reflecting surface 111 and the second reflecting surface 112 may be different from the number of times of reflection of the light L by each of the third reflecting surface 113 and the fourth reflecting surface 114.

For example, the light transmittance of the first reflecting surface 111 is substantially the same as the light transmittance of the third reflecting surface 113. The number of times of reflection of the light L by each of the first reflecting surface 111 and the second reflecting surface 112 is the same as the number of times of reflection of the light L by each of the third reflecting surface 113 and the fourth reflecting surface 114. In this case, the same optical member can be used for the first reflecting surface 111 and the third reflecting surface 113, and the same optical member can be used for the second reflecting surface 112 and the fourth reflecting surface 114. For example, the distance measurement device 2 can be easily manufactured, and the cost of the distance measurement device 2 can be reduced.

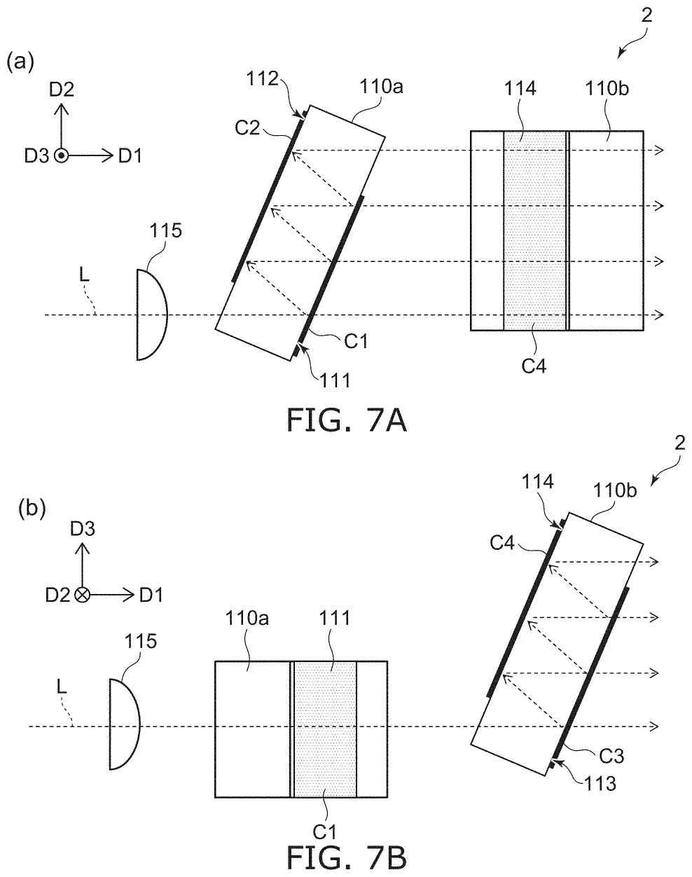

FIG. 7A and FIG. 7B are schematic views showing a portion of the distance measurement device according to the second embodiment.

For example, as shown in FIG. 7A and FIG. 7B, the first reflecting surface 111 and the second reflecting surface 112 are provided to one first member 110a similar to the structure shown in FIG. 3. The third reflecting surface 113 and the fourth reflecting surface 114 are provided to one second member 110b. Specifically, a coating C3 is formed on a portion of one surface of the second member 110b. A coating C4 is formed on a portion of the opposite surface of the second member 110b. The coating C3 allows the light L to partially pass through the coating C3. The coating C4 reflects light L. The coatings C3 and C4 respectively function as the third reflecting surface 113 and the fourth reflecting surface 114.

The first member 110a allows the light L to pass through the first member 110a between the first reflecting surface 111 and the second reflecting surface 112. The second member 110b allows the light L to pass through the second member 110b between the third reflecting surface 113 and the fourth reflecting surface 114. For example, the first member 110a and the second member 110b are prisms. The first member 110a and the second member 110b are used, so that it is not necessary to adjust the positional relationship between the first reflecting surface 111 and the second reflecting surface 112 and to adjust the positional relationship between the third reflecting surface 113 and the fourth reflecting surface 114. For example, the distance measurement device 2 can be easily manufactured. A variation in performance of the distance measurement device 2 can be reduced.

In the distance measurement device 2, similarly to the distance measurement device 1 shown in FIG. 2, the path of the light L emitted from the light projecting unit 100 may be changed by the rotating part 302. Alternatively, similarly to the distance measurement device 1a shown in FIG. 4, the path of the light L may be changed by the first mirror 310. For example, the first mirror 310 is selected from any of polygon mirrors, rotating mirrors, and swinging mirrors.

(First Variation)

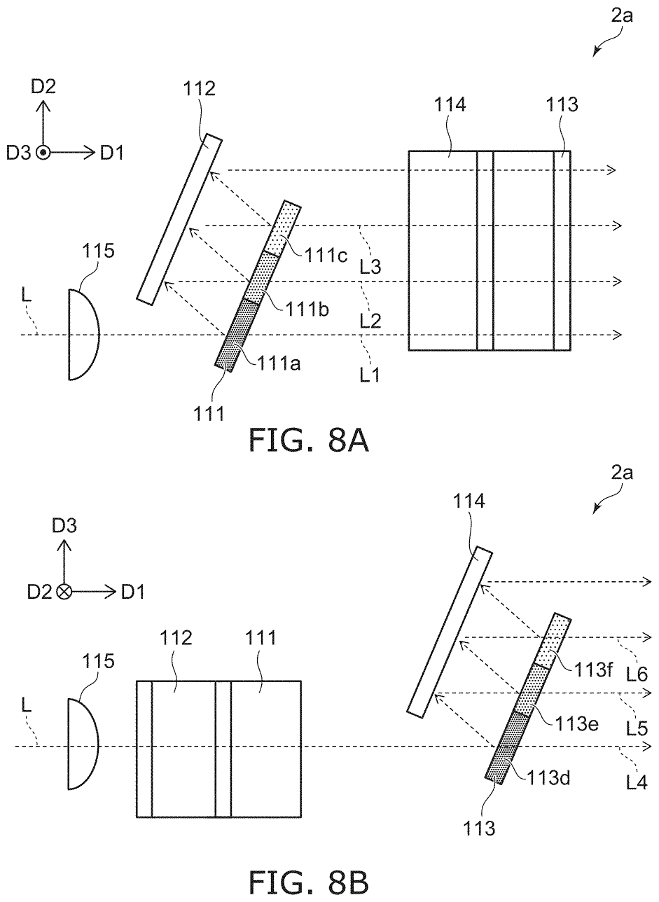

FIG. 8A and FIG. 8B are schematic views showing a portion of a distance measurement device according to a first variation of the second embodiment.

In a distance measurement device 2a according to the first variation, as shown in FIG. 8A, similarly to the distance measurement device 1b, the first reflecting surface 111 includes the first region 111a to the third region 111c. The light transmittances of the first region 111a to the third region 111c are different from each other. Accordingly, it is possible to reduce the variation in illuminance among the light L1 to the light L3 passing through the first reflecting surface 111.

The third reflecting surface 113 includes a fourth region 113d to a sixth region 113f. The light transmittances of the fourth region 113d to the sixth region 113f are different from each other.

In FIG. 8, the path of the light L in the distance measuring device 2a is schematically shown. In addition, the refractions of the light L when the light L is incident on each of the first to fourth reflecting surfaces 111 to 114 and when the light L is emitted from each of the first to fourth reflecting surfaces 111 to 114 are omitted in FIG. 8. For example, the light L divided by the first reflecting surface 111 and the second reflecting surface 112 is first incident on the fourth region 113d as shown in FIG. 8. Next, the light L reflected by the fourth reflecting surface 114 is incident on the fifth region 113e. The light L further reflected by the fourth reflecting surface 114 is incident on the sixth region 113f.

When the light transmittance of the third reflecting surface 113 is uniform, the illuminance of light L5 passing through the fifth region 113e is smaller than the illuminance of light L4 passing through the fourth region 113d. The illuminance of light L6 passing through the sixth region 113f is smaller than the illuminance of the light L5 passing through the fifth region 113e. As the number of times of reflection by the third reflecting surface 113 and the fourth reflecting surface 114 is increased, the illuminance of the light passing through the third reflecting surface 113 is decreased.

In the third reflecting surface 113, as the number of times of reflection by the third reflecting surface 113 and the fourth reflecting surface 114 is increased, the transmittance of the region on which the light L is incident is increased. Accordingly, the variation in illuminance among the light L4 to the light L6 can be reduced.

According to the light projecting unit or the distance measurement device described above, even when the intensity of the light L emitted from the light source 102 is increased, the illuminance of the light L can be reduced. For example, the amount of light can be increased while maintaining the illuminance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. The above embodiments can be practiced in combination with each other.

What is claimed is:

1. A distance measurement device, comprising:
a light projecting unit projecting light to a target; and
a light receiving unit detecting the light reflected by the target,
the light projecting unit including:
a light source emitting light;
a first reflecting surface allowing the light to partially pass through the first reflecting surface; and
a second reflecting surface facing the first reflecting surface and reflecting the light, and
the light being reflected a plurality of times by each of the first reflecting surface and the second reflecting surface.

2. The device according to claim 1, wherein
the light source emits the light toward a first direction, and
the first reflecting surface and the second reflecting surface are inclined with respect to the first direction and a second direction perpendicular to the first direction.

3. The device according to claim 2, wherein
the light projecting unit further includes:
a third reflecting surface allowing the light to partially pass through the third reflecting surface; and
a fourth reflecting surface facing the third reflecting surface and reflecting the light,
the third reflecting surface and the fourth reflecting surface are inclined with respect to the first direction and a third direction perpendicular to the first direction and the second direction, and
the light is reflected a plurality of times by each of the third reflecting surface and the fourth reflecting surface.

4. The device according to claim 3, wherein
a diameter of the light emitting surface of the light source in the second direction is larger than a diameter of the light emitting surface in the third direction, and
the light reflected by the first reflecting surface and the second reflecting surface is incident on the third reflecting surface and the fourth reflecting surface.

5. The device according to claim 3, wherein
a transmittance of the light on the first reflecting surface is substantially same as a transmittance of the light on the third reflecting surface.

6. The device according to claim 3, wherein
a number of times of reflection of the light on each of the first reflecting surface, the second reflecting surface, the third reflecting surface, and the fourth reflecting surface is same.

7. The device according to claim 1, wherein
the light projecting unit further includes a collimator lens, and
the light passing through the collimator lens is incident on the first reflecting surface and the second reflecting surface.

8. The device according to claim 1, further comprising:
a first member having the first reflecting surface and the second reflecting surface.

9. The device according to claim 1, further comprising:
a movable first mirror,
the light reflected by the first reflecting surface and the second reflecting surface being incident on a portion of the first mirror and reflected toward the target, and
the light reflected by the target being incident on other portion of the first mirror and reflected toward the light receiving unit.

10. The device according to claim 9, wherein
the first mirror rotates or swings around a first axis, and
a direction connecting the portion of the first mirror and the other portion of the first mirror is parallel to the first axis.

11. The device according to claim 9, wherein
the first mirror is a polygon mirror, a rotating mirror, or a swinging mirror.
